(19) United States
(12) Patent Application Publication
(10) Pub. No.: US 2009/0047533 A1
(43) Pub. Date: Feb. 19, 2009

(54) COMPOSITION AND METHOD FOR TREATING FIBROUS MATERIALS

(75) Inventors: JOSEPH F. WARCHOL, NORRISTOWN, PA (US); JOSEPH F. BARBIERI, RICHBORO, PA (US); SALVATORE DESIMONE, BRIDGEPORT, PA (US); LESLIE J. O'REILLY, CORNING, NY (US)

Correspondence Address: HOWSON AND HOWSON, SUITE 210, 501 OFFICE CENTER DRIVE, FT WASHINGTON, PA, 19034, US

(73) Assignee: HOUGHTON TECHNICAL CORP., Wilmington, DE (US)

(21) Appl. No.: 12/034,061

(22) Filed: Feb. 20, 2008

Related U.S. Application Data
(60) Provisional application No. 60/955,689, filed on Aug. 14, 2007.

(51) Int. Cl. B32B 29/06; A01N 33/12; A01P 3/00; A01P 1/00; E04C 2/10

(52) U.S. Cl. 428/537.5; 514/642; 52/506.05

(57) ABSTRACT

Compositions useful in preventing fungal and bacterial growth in fibrous substrates, e.g., paper, are provided. These compositions also advantageously do not corrode metal substrates that are attached and/or adjacent to the fibrous substrate. The compositions contain didecyl dimethyl ammonium bicarbonate and didecyl dimethyl ammonium carbonate (DDABC), a water-soluble cationic salt of ethylene diamine tetraacetic acid, optionally water, and optionally an agent which complexes said water-soluble cationic salt of ethylene diamine tetraacetic acid. Also provided are products containing these compositions and methods of using the same.

### CROSS-REFERENCE TO RELATED APPLICATIONS

This application claims the benefit of the priority of U.S. Provisional Patent Application No. 60/955,689, filed Aug. 14, 2007.

### BACKGROUND OF THE INVENTION

Fibrous materials, typically paper, are used as coversheets for gypsum wallboard and other building material. It is well known in the art that gypsum wallboard is susceptible to moisture accumulation due to leaks, condensation, and flooding, among others, thereby permitting the growth of mold and bacteria in and/or on the wallboard. The wallboard also often comes into contact with metallic substrates such as metal fasteners. These metallic substrates are prone to chemical oxidation, i.e., corrosion, and microbially induced corrosion (MIC). It is therefore necessary to treat and/or replace the wallboard and metallic surfaces, which can be costly.

Conventional antifungal agents and antimicrobial agents may be used to prevent mold and bacterial growth in both the fibrous material, e.g., wallboard, and on the metallic surfaces. Such agents include zinc and sodium omadine, diiodomethyl-para-tolylsulfone (the Amical Flowable® reagent available from Dow Chemical), 3-iodo-2-propynyl butylcarbonate (IPBC), and 2-n-octyl-4-isothiazolin-3-one. However, these agents alone do not adequately penetrate the fibrous substrates due to their weak surface active properties; such agents also can be quite expensive. In order to increase their penetration into fibrous substrates, these agents must be combined with an amphipathic material such as a surfactant. However, even the combination of antifungal and/or antimicrobial agents with surfactants does not impart corrosion resistance to the metal substrate that comes into contact with the wallboard.

A number of chemical compounds are available that are antifungal and/or antimicrobial agents and surfactants and include halogen containing quaternary ammonium salts. Examples of these quaternary ammonium salts include cetyl pyridinium chloride (CPC), didecyl dimethylammonium bromide, and benzyl triethylammonium iodide. However, these compounds are corrosive to metallic substrates and are therefore less desirable for treating any fibrous substrates that come into contact with metal substrates.

Non-halogen containing quaternary ammonium salts are also known and include didecyl dimethyl ammonium bicarbonate/carbonate (DDABC). This compound is known to provide corrosion protection to metal substrates and is the active ingredient in several formulations (Lonza, Switzerland).

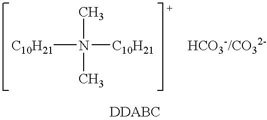

What is needed in the art are compositions that more efficiently provide antifungal and/or antimicrobial protection to fibrous substrates.

### SUMMARY OF THE INVENTION

In one aspect, a composition is provided and contains didecyl dimethyl ammonium bicarbonate, didecyl dimethyl ammonium carbonate, a water-soluble cationic salt of ethylene diamine tetraacetic acid, optionally water, and optionally an agent which complexes the water-soluble cationic salt of ethylene diamine tetraacetic acid.

In another aspect, a composition is provided and contains (a) about 18% by weight of didecyl dimethyl ammonium bicarbonate and didecyl dimethyl ammonium carbonate, (b) about 7.4% by weight of the sodium salt of ethylene diamine tetraacetic acid, and (c) about 70% by weight of water.

In a further aspect, a composition is provided and contains (a) about 13.5% by weight of didecyl dimethyl ammonium bicarbonate and didecyl dimethyl ammonium carbonate, (b) about 5.6% by weight of the sodium salt of ethylene diamine tetraacetic acid, (c) about 2.3% by weight of calcium acetate; and (d) about 75% by weight of water.

In still a further aspect, a composition is provided and contains (a) about 20.5% by weight of didecyl dimethyl ammonium bicarbonate and didecyl dimethyl ammonium carbonate, (b) about 6.1% by weight of the sodium salt of ethylene diamine tetraacetic acid, (c) about 2.5% by weight of calcium acetate; and (d) about 66% by weight of water.

In yet another aspect, a fibrous substrate is provided and contains didecyl dimethyl ammonium bicarbonate, didecyl dimethyl ammonium carbonate, a water-soluble cationic salt of ethylene diamine tetraacetic acid, optionally water, and optionally an agent which complexes the water-soluble cationic salt of ethylene diamine tetraacetic acid.

In still a further aspect, a method is provided for preventing fungal growth, bacterial growth, or a combination thereof on a fibrous substrate that contains and/or is adjacent to a metal substrate. The method includes treating the fibrous substrate with a composition as described above which prevents corrosion of the metal substrate. The composition contains didecyl dimethyl ammonium bicarbonate, didecyl dimethyl ammonium carbonate, a water-soluble cationic salt of ethylene diamine tetraacetic acid, optionally water, and optionally an agent which complexes the water-soluble cationic salt of ethylene diamine tetraacetic acid.

In yet another aspect, a method for hanging a fibrous wallboard is provided and includes hanging the fibrous wallboard on a wall using metal fasteners or metal equipment. The fibrous wallboard is impregnated with a composition that contains didecyl dimethyl ammonium bicarbonate, didecyl dimethyl ammonium carbonate, and a water-soluble cationic salt of ethylene diamine tetraacetic acid. Desirably, the wallboard does not corrode the metal fasteners or equipment.

Other aspects and advantages of the invention will be readily apparent from the following detailed description of the invention.

### DETAILED DESCRIPTION OF THE INVENTION

The present invention satisfies the need in the art for a composition that not only protects fibrous substrates from mold and/or bacteria, but also reduces surface tension, thereby permitting penetration of the composition into the fibrous substrate. The composition also advantageously does not corrode metal substrates that are attached, used with, and/or adjacent to the fibrous substrate.

The term “fibrous substrate” as used herein refers to any solid substrate that contains fibers. Desirably, the fibers are natural and include vegetable or bio-derived fibers containing cellulose. The fibrous substrate may also contain synthetic fibers such as polypropylene, polyethylene, polyamides, and polyesters among others. Examples of fibrous substrates useful herein include, without limitation, paper, cardboard, wallpaper, insulation, carpeting, ceiling tiles, textiles such as fabrics, or wallboard. The fibrous substrate may be affixed to a more rigid substrate. The cardboard may be in any form including a container that includes cardboard, i.e., a cardboard box. For example, the fibrous substrate, e.g., paper, may be affixed to wallboard or drywall, including gypsum board which is available in the art and described in US Patent Publication Nos. US-2003/0031898, US-2006/0171976, US-2003/0037502, and US-2007/00821170, US Pat. No. 6,767,647, and Kirk-Othmer Encyclopedia of Chemical Technology, 2^{nd} Ed., Volume 21, pages 621-624, 1970, which are all incorporated herein by reference.

The fibrous substrate may also have one or more metal substrates attached and/or adjacent thereto. The term “metal substrate” as used herein refers to a substrate that contains one or more of iron, tin, aluminum, copper, zinc, or combinations thereof, among others, which may readily be selected by one of skill in the art. Typically, the metal substrate corrodes when exposed to water and air. A metal substrate may therefore include metal supports used to support ceiling tiles, metal construction equipment used to hang wallboard and/or ceiling tiles, and/or any equipment utilized to prepare, position, or support the fibrous substrate alone or attached to a more rigid substrate. Examples of metal substrates that may be attached and/or adjacent to the fibrous substrate include, without limitation, one or more metal fasteners, metal clips, metal nails, metal screws, metal staples, metal pipes, metal supports, metal anchors, and metal equipment among others. The fibrous substrates discussed herein contain the compositions discussed below.

### I. The Composition

As a distinguishing characteristic from other antifungal and/or antibacterial agents in the art, the compositions described herein lack one or more reagents which corrode metal substrates. These compositions specifically lack halogenated ammonium salts, which are asserted in the art to prevent bacteria growth, but have the disadvantage of corroding metals.

As discussed above, the compositions presented herein impart antifungal and/or antibacterial properties to fibrous substrates and reduce surface tension, thereby permitting penetration of the composition into the fibrous substrate. These compositions also do not corrode metal substrates that come into contact with the fibrous substrate. The first component of the composition is didecyl dimethyl ammonium bicarbonate/carbonate (DDABC) which is a mixture of didecyl dimethyl ammonium bicarbonate and didecyl dimethyl ammonium carbonate. DDABC is available from Lonza as the CarboShield™ 1000 formulation. The DDABC in the composition acts as a surfactant and reduces surface tension, thereby permitting penetration of the composition into the fibrous substrate. The DDABC also permits better coverage of the composition when applied to the fibrous substrate. In fact, it is an advantage of the composition provided herein that it does not contain any surfactants other than DDABC. Further, DDABC is less expensive than other typical antifungal or antimicrobial agents utilized in the art for coating fibrous substrates. The composition desirably contains about 10 to about 50% by weight, and fractional percentages therebetween, of DDABC. In one embodiment, the composition contains about 10, 15, 20, 25, 30, 35, 40, 45, or 50% by weight of DDABC. In another embodiment, the composition contains about 12 to about 25% by weight of DDABC. In a further embodiment, the composition contains about 12, 13, 14, 15, 16, 17, 18, 19, 20, 21, 22, 23, 24, or 25% by weight of DDABC. In still another embodiment, the composition contains about 18% by weight of DDABC. In a further embodiment, the composition contains about 13.5% by weight of DDABC. In another embodiment, the composition contains about 20.5% by weight of DDABC.

As a second component, the composition contains a water-soluble cationic salt of ethylene diamine tetraacetic acid (EDTA). Desirably, the water-soluble cationic salt of EDTA imparts additional antifungal and antibacterial properties to the composition. One of skill in the art would readily understand and recognize water-soluble cationic salts of EDTA that may be selected for use in the compositions described herein. A variety of water-soluble cationic salts of EDTA is available in the art and includes, without limitation, sodium, potassium, calcium, magnesium, iron (II), iron (III), and aluminum (III) salts, among others. Due to the low cost, the water-soluble cationic salt of EDTA is desirably selected as the corresponding sodium salt, i.e., Na₄ EDTA. The composition desirably contains about 3% to about 13% by weight, and fractional percentages therebetween, of the water-soluble cationic salt of EDTA. In one embodiment, the composition contains 3, 4, 5, 6, 7, 8, 9, 10, 11, 12, or 13% by weight of the water-soluble cationic salt of EDTA. In another embodiment, the composition contains about 5 to about 10% by weight of the water-soluble cationic salt of EDTA. In a further embodiment, the composition contains about 8% by weight of the water-soluble cationic salt of EDTA. In yet another embodiment, the composition contains about 5.5% by weight of the water-soluble cationic salt of EDTA. In still a further embodiment, the composition contains about 6.1% by weight of the water-soluble cationic salt of EDTA.

The composition may also contain a carrier. Desirably, the carrier is water. However, other carriers may be utilized in the composition and may be readily selected by one of skill in the art. The water utilized in the composition may be deionized water, lake water, tap water, well water, or recycled industrial water, among others. The composition desirably contains about 20% to about 85% by weight, and fractional percentages therebetween, of water. In one embodiment, the composition contains 20, 25, 30, 35, 40, 45, 50, 55, 60, 65, 70, 75, 80, or 85% by weight of water. In another embodiment, the composition contains about 40 to about 85% by weight of water. In a further embodiment, the composition contains about 62% to about 85% by weight of water. In another embodiment, the composition contains about 70% to about 80% by weight of water. In a further embodiment, the composition contains about 66% by weight of water. In yet another embodiment, the composition contains about 70% by weight of water. In still another embodiment, the composition contains about 75% by weight of water. In yet a further embodiment, the composition contains about 79% by weight of water.

The water utilized in the composition will depend on the source thereof and may be hard or soft water. The terms “hard” and “soft” to describe water are known in the art and describe the mineral content of the water. See, “Hardness” in the Betz Handbook of Industrial Water Conditioning, 6^{th} Ed., Chapter 55, Beta Laboratories, Inc., Philadelphia, Pa., 1962, page 367, which is hereby incorporated by reference.

The composition may also contain a chemical compound which prevents phase separation of the composition. In one embodiment, the chemical compound is an agent which complexes the water-soluble cationic salt of EDTA. One of skill in the art would be able to select a suitable agent to complex the water-soluble cationic salt of EDTA. Examples of suitable complexing agents include, without limitation, calcium salts such as calcium acetate, magnesium salts, such as magnesium acetate, or combinations thereof. The composition may contain about 0.5% to about 5%, and fractional percentages therebetween, by weight of the complexing agent. In one embodiment, the composition may contain about 0.5, 1, 1.5, 2, 2.5, 3, 3.5, 4, 4.5, or 5% by weight of the complexing agent. In another embodiment, the composition may contain about 1% to about 2.5% by weight of the complexing agent. In a further embodiment, the composition may contain about 2.3% by weight of the complexing agent. In still a further embodiment, the composition may contain about 2.5% by weight of the complexing agent.

The composition may also contain additional antifungal and/or antibacterial agents as determined by one of skill in the art depending on the environmental conditions, fibrous substrate being treated, expected mold and/or bacteria growth, among others.

The composition may further contain other components which do not affect the antifungal, antimicrobial, surfactant, or corrosive properties of the composition. In one example, the composition may contain didecyl dimethyl amine. In one embodiment, the composition contains about 0.3 to about 0.5% by weight of didecyl dimethyl amine. In a further embodiment, the composition contains about 0.3, 0.35, 0.4, 0.45, or 0.5%, or fractional percentages therebetween, by weight of didecyl dimethyl amine. In another embodiment, the composition contains about 0.4% by weight of didecyl dimethyl amine. In yet a further embodiment, the composition contains about 0.3% by weight of didecyl dimethyl amine. In a further example, the composition may contain methanol. In one embodiment, the composition contains about 0.8 to about 1.3% by weight of methanol. In a further embodiment, the composition contains about 0.8, 0.9, 1.0, 1.1, 1.2, or 1.3%, or fractional percentages therebetween, by weight of methanol. In another embodiment, the composition contains about 1.2% by weight of methanol. In still a further embodiment, the composition contains 0.9% by weight of methanol. In another example, the composition may contain propylene glycol. In one embodiment, the composition contains about 1.8 to about 3% by weight of propylene glycol. In a further embodiment, the composition contains about 1.8, 1.9, 2.0, 2.1, 2.2, 2.3, 2.4, 2.5, 2.6, 2.7, 2.8, 2.9, or 3%, or fractional percentages therebetween, by weight of propylene glycol. In another embodiment, the composition contains about 2.5% by weight of propylene glycol. In yet a further embodiment, the composition contains about 1.9% by weight of propylene glycol.

The composition is prepared by mixing the components of the composition with water. In one embodiment, the components are combined at once with water and mixed. In another embodiment, one or more components of the composition are combined with water and the remaining components added. In a further embodiment, the DDABC, the water-soluble cationic salt of EDTA, and optional agent which complexes with the water-soluble cationic salt of EDTA are combined with a small aliquot of the water to form a mixture. This mixture is then combined with a second, larger aliquot of water. The term “small amount” as used herein refers to less than about 30% by volume of the water. Desirably, the term “small amount” refers to about 25% by volume of the water. In one embodiment, the DDABC and the water-soluble cationic salt of EDTA are combined with 25% by volume of the water. This mixture is then combined with the remaining 75% of the water. In another embodiment, the DDABC, the water-soluble cationic salt of EDTA, and agent which complexes the water-soluble cationic salt of EDTA are combined with the 25% of the water. This mixture is then combined with the remaining 75% of the water.

In one embodiment, the composition contains about 18% by weight of didecyl dimethyl ammonium bicarbonate and didecyl dimethyl ammonium carbonate, about 7.4% by weight of the sodium salt of ethylene diamine tetraacetic acid, and about 70% by weight of water.

In a further embodiment, the composition contains about 13.5% by weight of didecyl dimethyl ammonium bicarbonate and didecyl dimethyl ammonium carbonate, about 5.6% by weight of the sodium salt of ethylene diamine tetraacetic acid, about 2.3% by weight of calcium acetate, and about 75% by weight of water.

In another embodiment, the composition and contains (a) about 23% by weight of didecyl dimethyl ammonium bicarbonate; didecyl dimethyl ammonium carbonate, didecyl dimethyl amine, methanol, and propylene glycol, (b) about 7.4% by weight of the sodium salt of ethylene diamine tetraacetic acid; and (c) about 69.6% by weight of water.

In still a further embodiment, the composition contains (a) about 17.3% by weight of didecyl dimethyl ammonium bicarbonate, didecyl dimethyl ammonium carbonate, didecyl dimethyl amine, methanol, and propylene glycol; (b) about 5.5% by weight of the sodium salt of ethylene diamine tetraacetic acid; (c) about 2.3% by weight of calcium acetate; and (d) about 74.9% by weight of water.

In yet another embodiment, the composition contains (a) about 25.3% by weight of didecyl dimethyl ammonium bicarbonate, didecyl dimethyl ammonium carbonate, didecyl dimethyl amine, methanol, and propylene glycol; (b) about 6.1% by weight of the sodium salt of ethylene diamine tetraacetic acid; (c) about 2.5% by weight of calcium acetate; and (d) about 66% by weight of water.

### II. Product Containing the Composition

The composition described herein can be provided to the customer as a concentrated neat composition, requiring dilution or as a ready for use composition, requiring no dilution. In one embodiment, the carrier, e.g., water, is included in the composition in the product, thereby permitting use of the product by the customer without addition of further water. In another embodiment, the water is present in the composition in sufficient amounts to provide a stable solution for further dilution by the customer prior to use.

A product is therefore provided and contains the composition described above or the components utilized to prepare the same. In one embodiment, the product includes a first container which contains the DDABC and a second container which contains the water-soluble cationic salt of EDTA. The product can also include a third container which contains calcium acetate, magnesium acetate, or a combination thereof. The product can further include instructions for mixing the components of the containers, among others.

In a further embodiment, the product includes one container which includes DDABC, the water-soluble cationic salt of EDTA, optionally water, and optionally calcium acetate, magnesium acetate, or a combination thereof.

In another embodiment, a product is provided and includes a first container containing about 18% by weight of DDABC and a second container containing about 7.4% by weight of the sodium salt of ethylene diamine tetraacetic acid.

In a further embodiment, a product is provided and includes a first container 10 including about 13.5% by weight of didecyl dimethyl ammonium bicarbonate and didecyl dimethyl ammonium carbonate, a second container including about 5.6% by weight of the sodium salt of ethylene diamine tetraacetic acid, and a third container including about 2.3% by weight of calcium acetate.

### III. Methods of Using the Composition

The composition described herein may be utilized for a variety of purposes. In one embodiment, the composition is utilized to prevent the growth of mold and/or bacteria on a fibrous substrate. The composition is thereby applied to the fibrous substrate using techniques known in the art. Desirably, the composition is applied to the fibrous substrate using brushing, spraying, or immersion techniques known and readily selected by one skilled in the art. By doing so, the fibrous substrate is impregnated, dispersed, and/or coated with the composition, i.e., the fibrous substrate contains the composition.

In another embodiment, the composition is utilized to prevent the corrosion of one or more metal substrates attached and/or adjacent to the fibrous substrate. This technique is particularly useful in preventing the corrosion of metal nails, metal screws, metal fasteners, metal staples, or the like, that may be attached to the fibrous material. The composition is also useful in preventing corrosion of metal substrates that are not attached to the fibrous substrate, but come into contact with the fibrous substrate, i.e., are adjacent to the fibrous substrate. For example, the composition can prevent corrosion of metal supports, e.g., wall beams, ceiling tile frames, among others. Further, the composition prevents the corrosion of metal equipment that comes into contact with the fibrous substrate. Examples of metal equipment can include, without limitation, metal machinery, metal hammers, metal screws, drill bits, among others.

In a further embodiment, the composition is utilized to treat a fibrous substrate which contains mold and/or bacteria. The composition is thereby applied to the fibrous substrate using techniques known in the art. Desirably, the composition is applied to the fibrous substrate using brushing, spraying, or immersion techniques known and readily selected by one skilled in the art. By doing so, the fibrous substrate is impregnated, dispersed, and/or coated with the composition.

One exemplary method of using the composition described herein includes hanging a fibrous wallboard using one or more pieces of equipment or machinery. Desirably, the wallboard does not corrode the metal equipment or machinery. The method includes hanging the fibrous wallboard on a wall using metal equipment, wherein the fibrous wallboard contains a composition described herein.

The following examples are illustrative only and are not intended to be a limitation on the present invention.

### EXAMPLES

### Example 1

### Antifungal Testing on Paper

The use of DDABC alone or in combination with other components in treating paper products was studied. The method was based on ASTM (American Society of Testing and Materials now known as ASTM International, G-21 “Determining Resistance of Synthetic Polymeric Materials to Fungi”). The testing was performed according to the following procedure:

### A. Preparation of Test Samples:

1. Approximate 1 inch square sections of Kleenex® C-Fold (Kimberly-Clark) paper towels served as the paper samples for testing.
2. Individual 1 inch square paper samples were immersed in the appropriate test solution identified in Table 1 at the noted dilution rate until the paper was completely soaked by visual observation.
3. The treated paper samples were allowed to air dry.
4. After air drying, the treated paper samples were immersed in water completely soaking the paper.
5. Each treated paper sample was allowed to air dry again.
6. Each treated paper sample was immersed in water a second time to completely soak the paper.
7. Each treated paper sample was allowed to air dry again.
8. When dry, the treated paper samples were ready to be inoculated as described below.
9. Untreated 1 inch paper samples served as the test controls.

TABLE 1

| | | Dilution | |
|---|---|---|---|
| | | Rate | |
| Composition/Concentration (%) | Run | (%) | Active Agent(s)/Concentration (%) |
| Control Paper without biocide | 1 | N/A | N/A |
| | 2 | | |
| DDABC (50), H₂O (50) | 1 | 0.05 | DDABC (0.025) |
| | 2 | 0.05 | DDABC (0.025) |
| DDABC (18), Na₄EDTA (8), H₂O (74) | 1 | 0.06 | DDABC (0.011), Na₄EDTA (0.005) |
| | 2 | | |
| DDABC (18), Na₄EDTA (8), H₂O (74) | 1 | 0.125 | DDABC (0.023), Na₄EDTA (0.01) |
| | 2 | | |
| DDABC (18), Na₄EDTA (8), H₂O (74) | 1 | 0.250 | DDABC (0.045), Na₄EDTA (0.02) |
| | 2 | | |
| DDABC (18), Na₄EDTA (8), H₂O (74) | 1 | 0.06 | DDABC (0.011), Na₄EDTA (0.005) |
| | 2 | | |
| DDABC (18), Na₄EDTA (8), H₂O (74) | 1 | 0.125 | DDABC (0.023), Na₄EDTA (0.01) |
| | 2 | | |
| DDABC (18), Na₄EDTA (8), H₂O (74) | 1 | 0.250 | DDABC (0.045), Na₄EDTA (0.02) |
| | 2 | | |
| diiodomethyl-para-tolyl-sulfone (40.5) | 1 | 0.1 | diiodomethyl-para-tolyl-sulfone (0.041) |
| | 2 | | |
| diiodomethyl-para-tolyl-sulfone (40.5) | 1 | 0.2 | diiodomethyl-para-tolyl-sulfone (0.081) |
| | 2 | | |
| diiodomethyl-para-tolyl-sulfone (40.5) | 1 | 0.4 | diiodomethyl-para-tolyl-sulfone (0.162) |
| | 2 | | |
| diiodomethyl-para-tolyl-sulfone (40.5) | 1 | 0.2 | diiodomethyl-para-tolyl-sulfone (0.081) |
| | 2 | | |
| diiodomethyl-para-tolyl-sulfone (40.5) | 1 | 0.4 | diiodomethyl-para-tolyl-sulfone (0.162) |
| | 2 | | |

*diiodomethyl-para-tolyl-sulfone is available as the Amical Flowable ™ reagent (Dow Chemical)

### B. Fungal Treatment and Test Procedure

1. The test medium was nutrient salts agar. This medium provided the mineral necessary for fungus (mold) growth without a carbon source. The carbon source necessary for growth came from the test sample.
2. The nutrient salts agar formulation (Table 2) followed the ASTM G-21 procedure described above.
3. The nutrient agar was sterilized by autoclaving (approximately 15 minutes and about 248° F.) and poured into open individual sterile Petri plates (100×15 mm type) until the plate was approximately half-full and immediately covered with the Petri plate top. The agar was allowed to solidify by cooling at room temperature. Plates that were not immediately used were stored in a refrigerator until use.
4. A spore suspension was separately prepared by covering the surface of a previously grown culture of fungus with sterile water and scraping the growth surface with a sterile loop. The resulting water with fungus fragments and spore was centrifuged leaving a pellet of spores in the bottom of the centrifuge tube. The water layer was discarded and the spore pellet was re-suspended in sterile water for use as an inoculum for the study.
5. The cultures were originally obtained from the American Type Culture Collection (ATCC). The fungal cultures used in this testing were Apsergillus niger (ATCC No. 9642), Chaetomium globosum (ATCC No. 6205), and Penicillium funiculosum (ATCC No. 11797, now referred to as Penicillium pinophilum). Separate spore suspensions for each species were equally combined for use as the inoculum.
6. Each treated 1 inch square paper sample was placed on the surface of the nutrient salts agar and soaked with the fungus spore suspension by dripping the suspension on the paper until it was completely wet. Untreated paper samples were also inoculated as a test control. At least one test control was included with each test group.
7. The plates were incubated at room temperature for at least 28 days. Groups of Petri plate test samples were sealed in plastic bags to maintain humidity and to keep the agar from drying. At least one untreated test control was included in each bag.
8. Untreated controls were observed at 7 days for growth. If growth had not occurred in the controls after 7 days, the test was invalidated and stopped. Only tests meeting the 7 day growth requirement in the control are presented in this study.
9. After 28 days, the test samples were evaluated for growth according to ASTM G-21. In some cases, tests were expanded beyond 28 days.

TABLE 2

| Ingredient | Concentration (g/L) |
|---|---|
| Potassium dihydrogen orthophosphate (KH₂PO₄) | 0.7 |
| Magnesium sulfate (MgSO₄•7 H₂O) | 0.7 |
| Ammonium sulfate (NH₄SO₄) | 1.0 |
| Sodium Chloride (NaCl) | 0.005 |
| Ferrous sulfate (FeSO₄•7 H₂O) | 0.002 |
| Zinc sulfate (ZnSO₄•7 H₂O) | 0.002 |
| Manganese sulfate (MnSO₄•H₂O) | 0.001 |
| Agar | 15.0 |
| Potassium monohydrogen orthophosphate (K₂HPO₄) | 0.7 |

### C. Evaluation of Test Samples

The test samples were visually evaluated for the growth of fungus by classifying the amount of fungus growth on the surface of paper and assigning a “Score” as determined in Table 3. The “score” results for each run and each composition is shown in Table 4.

TABLE 3

| Score | Growth | Surface Coverage (%) |
|---|---|---|
| 0 | None | 0 |
| 1 | Traces | <10 |
| 2 | Light | 10-30 |
| 3 | Medium | 30-60 |
| 4 | Heavy | >60 |
| 5 | Complete | 100 |

TABLE 4

| Composition/Concentration (%) | Run | Days | Score |
|---|---|---|---|
| Control Paper without biocide | 1 | 7 | 5 |
| | 2 | 7 | 5 |
| DDABC (50), H₂O (50) | 1 | 28 | 0 |
| | 2 | 28 | 0 |
| DDABC (18), Na₄EDTA (8), H₂O (74) | 1 | 28 | 0 |
| | 2 | 28 | 0 |
| DDABC (18), Na₄EDTA (8), H₂O (74) | 1 | 28 | 0 |
| | 2 | 28 | 0 |
| DDABC (18), Na₄EDTA (8), H₂O (74) | 1 | 28 | 0 |
| | 2 | 28 | 0 |
| DDABC (18), Na₄EDTA (8), H₂O (74) | 1 | 50 | 0 |
| | 2 | 50 | 0 |
| DDABC (18), Na₄EDTA (8), H₂O (74) | 1 | 50 | 0 |
| | 2 | 50 | 0 |
| DDABC (18), Na₄EDTA (8), H₂O (74) | 1 | 50 | 0 |
| | 2 | 50 | 0 |
| diiodomethyl-para-tolyl-sulfone (40.5) | 1 | 28 | 2 |
| | 2 | 28 | 0 |
| diiodomethyl-para-tolyl-sulfone (40.5) | 1 | 28 | 0 |
| | 2 | 28 | 0 |
| diiodomethyl-para-tolyl-sulfone (40.5) | 1 | 28 | 0 |
| | 2 | 28 | 0 |
| diiodomethyl-para-tolyl-sulfone (40.5) | 1 | 60 | 5 |
| | 2 | 60 | 2 |
| diiodomethyl-para-tolyl-sulfone (40.5) | 1 | 60 | 3 |
| | 2 | 60 | 5 |

In summary, the use of compositions containing DDABC alone and in combination with the sodium salt of EDTA for treating paper samples consistently resulted in treated paper that contained no evidence of mold. Not only did these compositions provide antifungal protection for one (1) week, but they continued to provide antifungal protection for 50 days.

In contrast, the use of compositions containing diiodomethyl-para-tolyl-sulfone, a known antifungal agent, for treating paper samples did not consistently result in mold free paper.

### Example 2

### Antifungal Testing on Wallboard

The use of DDABC alone or in combination with other components in treating paper that is adhered to gypsum wallboard was studied. These test results were compared with the results for (i) antifungal reagents available in the art and (ii) wallboards currently available in the art. The method was based on ASTM (American Society of Testing and Materials now known as ASTM International, G-21 “Determining Resistance of Synthetic Polymeric Materials to Fungi”). The testing was performed according to the following procedure:

### A. Preparation of Test Samples:

1. Approximate one inch square sections of untreated wallboard, which contained paper adhered to each side of the wallboard, served as the samples for testing.
2. Each paper side of the wallboard was coated using a Meyer bar with the test solutions (i)-(vi) described in Table 5 at the dilution rate provided in Table 5 until each paper side was completely soaked by visual observation.
3. The treated wallboard samples were allowed to air dry.

TABLE 5

| | Dilution Rate |
|---|---|
| Formulation | (pounds/ton of paper) |
| (i) no antifungal and antibacterial agents | N/A |
| (ii) a composition containing 100% of the Amical | 5.6 |
| Flowable ™ reagent | |
| (40% diiodomethyl-para-tolyl-sulfone) | |
| (iii) a composition containing 100% of the Amical | 1.1 |
| Flowable ™ reagent | |
| (iv) a composition containing 50% by weight of | 5.6 |
| DDABC and 50% water | |
| (v) a composition containing 18% by weight of | 1.1 |
| DDABC, 8% by weight of Na₄EDTA, and 74% | |
| by weight water | |
| (vi) a composition containing 50% by weight of | 1.1 |
| DDABC and 50% water | |

The test samples also included sections of gypsum wallboard that were available in the art and are identified as Purple Replicate A, Purple Replicate B, Blue Replicate A, Blue Replicate B, Green Replicate A, and Green Replicate B. These commercially available wallboards had been pre-treated by the manufacturer using an antifungal agent that did not contain DDABC.

Each paper side of the wallboard impregnated with formulations (i)-(vi) and the commercially available wallboards was then inoculated with the spore suspensions described in Example 1. The underside of each wallboard sample was then placed on the surface of a nutrient salts agar plate, prepared as described in Example 1. The topside of the wallboard was again inoculated with the same spore suspension. The top portion of the agar plate as then filled with sufficient nutrient salts agar to cover the exterior paper surface. The Petri plate was closed and gently tightened using tape. The plates were separately monitored under laboratory conditions in which the wallboard samples were sealed in plastic bags to maintain humidity and to keep the agar from drying and incubated at room temperature for at least 28 days.

The wallboard impregnated with formulations (i)-(vi) and commercially available wallboards were visually evaluated for the growth of fungus along the outer edges of the wallboard samples. The relative amount of fungal growth was assigned a “score” as set forth in Table 6. The result for each composition, wallboard, and run is shown in Table 7.

TABLE 6

| Growth of Bacteria | Score |
|---|---|
| No growth | 10 |
| Growth on wallboard surface between paper surfaces | 9 |
| only | |
| Growth on one paper edge | 8 |
| Growth on two paper edges | 7 |
| Growth on three paper edges | 6 |
| Growth on four paper edges | 5 |
| Growth on five paper edges | 4 |
| Growth on six paper edges | 3 |
| Growth on seven paper edges | 2 |
| Growth on eight paper edges, but no growth on | 1 |
| wallboard | |
| Growth on all eight paper edges and wallboard | 0 |

TABLE 7

| | Score |
|---|---|
| Formulation | |
| (i) | 0 |
| (ii) | 10 |
| (iii) | 0 |
| (iv) | 10 |
| (v) | 6* |
| (vi) | 0 |
| Commercially Available Wallboard | |
| Purple Replicate A | 0 |
| Purple Replicate B | 0 |
| Blue Replicate A | 9 |
| Blue Replicate B | 9 |
| Green Replicate A | 10 |
| Green Replicate B | 10 |

*Interior edges showed bacteria growth which may have interfered with mold growth

In summary, the use of compositions containing DDABC provided coated wallboard that resisted the growth of mold more than untreated commercially available wallboard. Further, the dilution rate, i.e., concentration, of the formulation was also found to be important in providing increased resistance to mold growth on the wallboard.

All publications cited in this specification are incorporated herein by reference. While the invention has been described with reference to particular embodiments, it will be appreciated that modifications can be made without departing from the spirit of the invention. Such modifications are intended to fall within the scope of the appended claims.

What is claimed is:

1. A composition comprising didecyl dimethyl ammonium bicarbonate, didecyl dimethyl ammonium carbonate and a water-soluble cationic salt of ethylene diamine tetraacetic acid.

2. The composition according to claim 1, further comprising an agent which complexes said water-soluble cationic salt of ethylene diamine tetraacetic acid.

3. The composition according to claim 2, wherein said agent is calcium acetate, magnesium acetate, or a combination thereof.

4. The composition according to claim 2, comprising about 0.5% to about 5% by weight of said agent.

5. The composition according to claim 1, wherein said water-soluble cationic salt of ethylene diamine tetraacetic acid is a sodium salt of ethylene diamine tetraacetic acid.

6. The composition according to claim 1, comprising about 10 to about 50% by weight of didecyl dimethyl ammonium bicarbonate and didecyl dimethyl ammonium carbonate.

7. The composition according to claim 1, comprising about 3% to about 13% by weight of the water-soluble cationic salt of ethylene diamine tetraacetic acid.

8. The composition according to claim 1, further comprising about 20% to about 85% by weight of water.

9. The composition according to claim 1, further comprising didecyl dimethyl amine.

10. The composition according to claim 9, comprising about 0.3 to about 0.5% by weight of didecyl dimethyl amine.

11. The composition according to claim 1, further comprising methanol.

12. The composition according to claim 11 comprising about 0.8 to about 1.3% by weight of methanol.

13. The composition according to claim 1, further comprising propylene glycol.

14. The composition according to claim 13, comprising about 1.8 to about 3% by weight of propylene glycol.

15. The composition according to claim 1, comprising:
(a) about 18% by weight of said didecyl dimethyl ammonium bicarbonate and didecyl dimethyl ammonium carbonate;
(b) about 7.4% by weight of said sodium salt of ethylene diamine tetraacetic acid; and
(c) about 70% by weight of water.

16. The composition according to claim 1, comprising:
(a) about 13.5% by weight of said didecyl dimethyl ammonium bicarbonate and didecyl dimethyl ammonium carbonate;
(b) about 5.6% by weight of said sodium salt of ethylene diamine tetraacetic acid;
(c) about 2.3% by weight of calcium acetate; and
(d) about 75% by weight of water.

17. A composition comprising:
(a) about 23% by weight of:
(i) didecyl dimethyl ammonium bicarbonate;
(ii) didecyl dimethyl ammonium carbonate;
(iii) didecyl dimethyl amine;
(iv) methanol; and
(v) propylene glycol;
(b) about 7.4% by weight of the sodium salt of ethylene diamine tetraacetic acid; and
(c) about 69.6% by weight of water.

18. A composition comprising:
(a) about 17.3% by weight of:
(i) didecyl dimethyl ammonium bicarbonate;
(ii) didecyl dimethyl ammonium carbonate;
(iii) didecyl dimethyl amine;
(iv) methanol; and
(v) propylene glycol;
(b) about 5.5% by weight of the sodium salt of ethylene diamine tetraacetic acid;
(c) about 2.3% by weight of calcium acetate; and
(d) about 74.9% by weight of water.

19. A composition comprising:
(a) about 25.3% by weight of:
(i) didecyl dimethyl ammonium bicarbonate;
(ii) didecyl dimethyl ammonium carbonate;
(iii) didecyl dimethyl amine;
(iv) methanol; and
(v) propylene glycol;
(b) about 6.1% by weight of the sodium salt of ethylene diamine tetraacetic acid;
(c) about 2.5% by weight of calcium acetate; and
(d) about 66% by weight of water.

20. A fibrous substrate comprising the composition of claim 1.

21. The fibrous substrate according to claim 20 which lacks a surfactant other than didecyl dimethyl ammonium bicarbonate, didecyl dimethyl ammonium carbonate, or a combination thereof.

22. A method for preventing fungal growth, bacterial growth, or a combination thereof on a fibrous substrate comprising or adjacent to a metal substrate, said method comprising treating said fibrous substrate with a composition of claim 1;
wherein said composition prevents corrosion of said metal substrate.

23. The method according to claim 22, wherein said composition further comprises an agent which complexes said water-soluble cationic salt of ethylene diamine tetraacetic acid.

24. A method for hanging a fibrous wallboard, comprising hanging said fibrous wallboard on a wall using metal fasteners or metal equipment, wherein said fibrous wallboard comprises a composition of claim 1;
wherein said wallboard does not corrode said metal fasteners or equipment.
